(19) United States
(12) Patent Application Publication
(10) Pub. No.: US 2009/0171517 A1
(43) Pub. Date: Jul. 2, 2009

(54) Shooshoo

(76) Inventor: Mehrdad Alavi, Camarillo, CA (US)

Correspondence Address: Mehrdad Alavi, 2731 Munson street, Camarillo, CA, 93010, US

(21) Appl. No.: 12/313,759

(22) Filed: Nov. 25, 2008

Related U.S. Application Data
(60) Provisional application No. 61/009,319, filed on Dec. 28, 2007.

(51) Int. Cl. G05D 1/08

(52) U.S. Cl. 701/4

(57) ABSTRACT

According to a preferred embodiment of present invention, a method and apparatus for Computer Controlled tail-rotor anti-torque system, utilizing stored momentum of rotating body as well as power change (speed and torque) with changing pitch is provided.

### CROSS-REFERENCE TO RELATED APPLICATIONS

This invention emanates from and relates to Provisional Patent Application 61/009,319 filed in the United States Patent and Trademark Office on Dec. 28, 2007.

### BACKGROUND OF THE INVENTION

1. Field of the Invention

This invention relates generally to a method and apparatus to counter torque in Helicopter's fuselage generated by Main rotor's rotation. In particular, the present invention relates to a method and apparatus, (mechanical fixture in combination with computer control “Fly By Wire”) tail rotor anti-torque system for a helicopter.

2. Description of Prior Art

Advantage of a helicopter over a fixed wing aircraft is that helicopter is able to take off and land vertically.

Another advantage of a helicopter over a fixed wing aircraft is that a helicopter, unlike a fixed wing aircraft, does not need a runway for take off or landing. An ability of a helicopter is to take off and travel in air due to rotating blades that revolve through air.

Most helicopters have two rotating blades, one single main rotor, and a tail rotor. A tail rotor is also called anti torque because tail rotor counters creation of torque by single main rotor mounted on top of a helicopter.

Present invention provides necessary anti-torque, and makes tail rotor more manageable. Furthermore present invention provides less drag and takes less horsepower from the engine in forward flight.

Although there are many methods and apparatus for countering torque created by a single main rotor, no relevant art was found that would anticipate or support method and apparatus of the present invention. The following will be referenced.

One such invention (U.S. Pat. No. 5,232,183) provides a helicopter anti-torque control system, which relies on engine exhaust. Included is a force generating apparatus and a force directing apparatus. The force generating apparatus is at least partly driven by engine exhaust. The force directing apparatus takes outside air delivered to it by the force generating apparatus and directs it from the helicopter as a right side or left-side force.

In another invention (U.S. Pat. No. 5,188,511), a helicopter anti-torque device direct pitch control is illustrated. The blade's angle controlling pitch beam servo of a helicopter tail rotor is responsive to a main rotor torque signal indicative of torque coupled to a helicopter main rotor for providing torque compensation so that the helicopter airframe will not counter-rotate under the main rotor. The torque coupled to the main rotor is that amount of engine torque in excess of torque coupled to the tail rotor and helicopter auxiliaries. The amount of torque compensation provided by the tail rotor is reduced by an amount indicative of aerodynamic forces on the helicopter airframe.

In yet another invention (U.S. Pat. No. 5,388,785), a single-rotor helicopter is provided to have a compound anti-torque system, and a method of countering the torque induced by said single rotor.

### SUMMARY OF INVENTION

Preferred embodiment of present invention provides an alternative method and apparatus for countering torque mechanism in a helicopter. In present invention, control of yaw can be accommodated without a traditional mechanically linked tail rotor. When a torque created by main rotor rotating clockwise, a tail rotor rotating via control of torque/horsepower of an electric power source 112, provides necessary momentum of rotation, and control of pitch of the tail rotor blades 100 provides anti-torque to keep helicopter's fuselage from spinning out of control.

### BRIEF DESCRIPTION OF THE DRAWINGS

FIG. 1 shows block diagram of present invention.

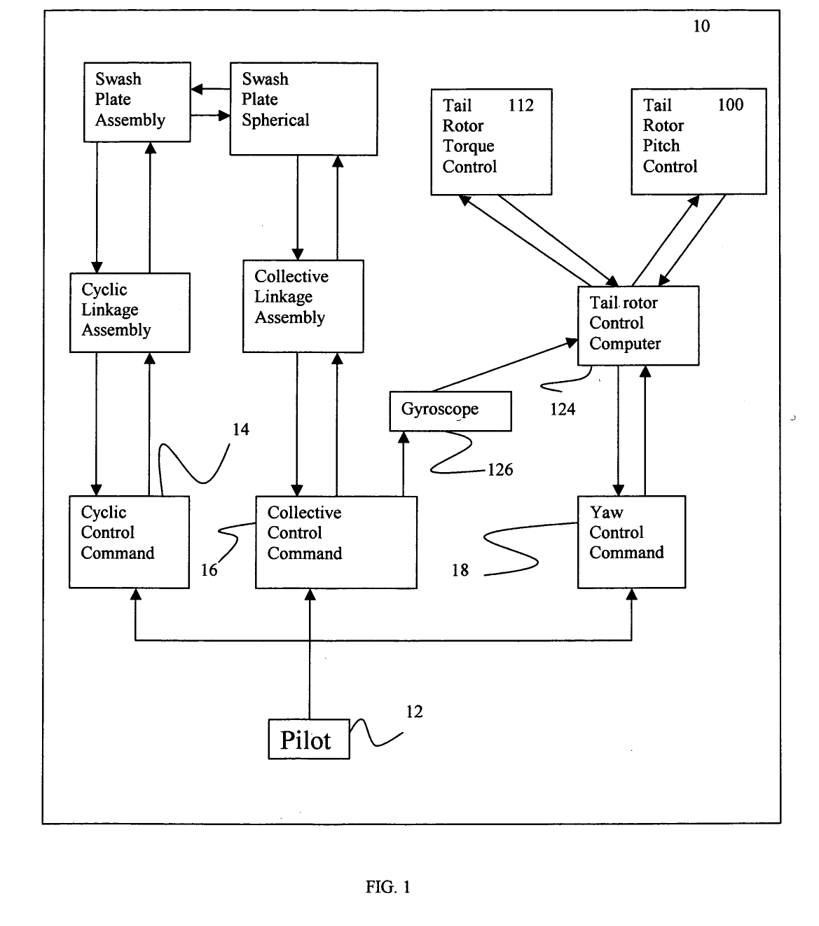

FIG. 2 displays block diagram of commands of present invention.

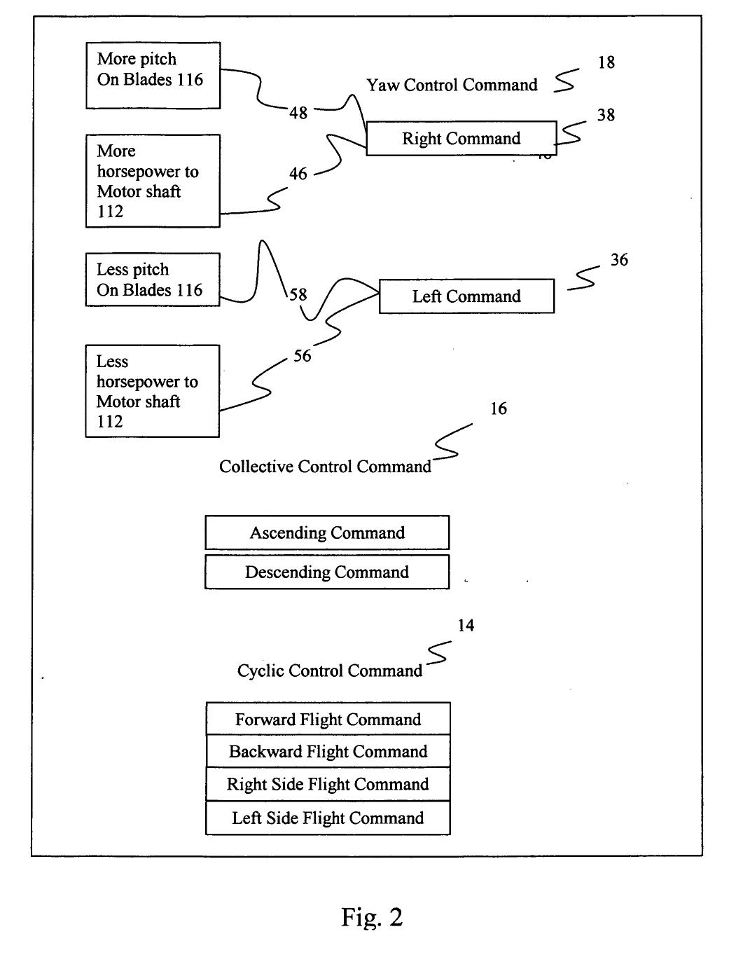

FIG. 3 illustrates exploded view of present invention.

FIG. 4 exhibits tail rotor connected to tail rotor control computer and Gyroscope.

FIG. 5 displays assembly perspective view of present invention.

FIG. 6 illustrates prospective view of tail-rotor with main rotor of present invention.

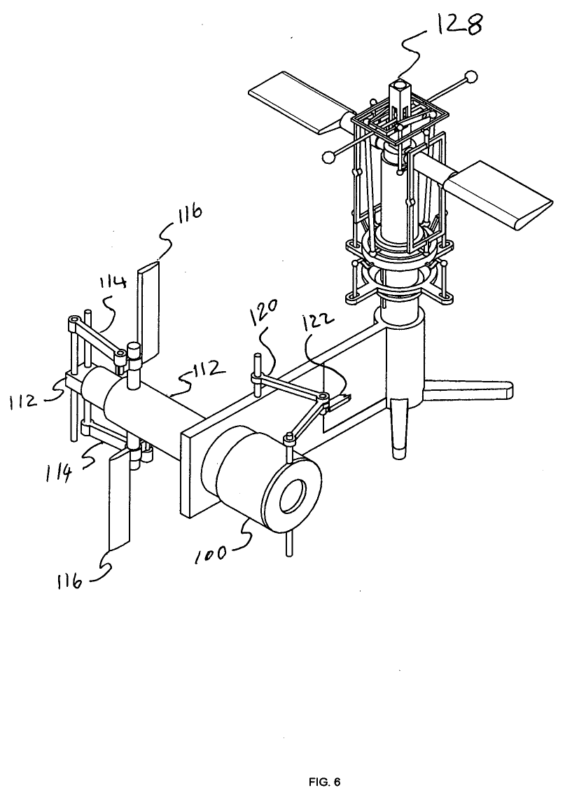

### DETAILED DESCRIPTION OF A PREFERRED EMBODIMENT OF THE INVENTION

The present invention now will be described more fully hereinafter with reference to the accompanying Drawing, in which a preferred embodiment of the invention is shown. This invention may, however, be embodied in many different but related forms and should not be construed as limited to embodiments set forth herein; rather, these embodiments are provided so that this disclosure will be thorough and complete, and will fully convey the scope of the invention to those skilled in the art. In the Drawing, like numbers refer to the same elements throughout the Figures of the Drawing.

Present invention 10 provides all necessary controls that are required for movement of a helicopter.

Specification of present invention 10 will be discussed by providing sequence of events, which is triggered when a helicopter pilot 12 who operates a helicopter issues a control command. Control commands for a helicopter are classified into three categories: Cyclic Control commands 14, Collective Control Commands 16 and Yaw Control commands 18.

### Yaw Control

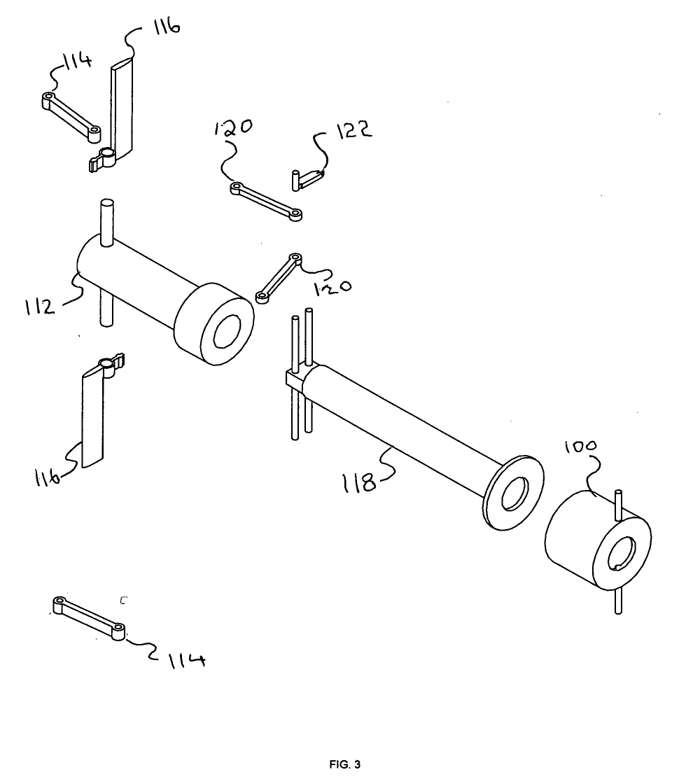

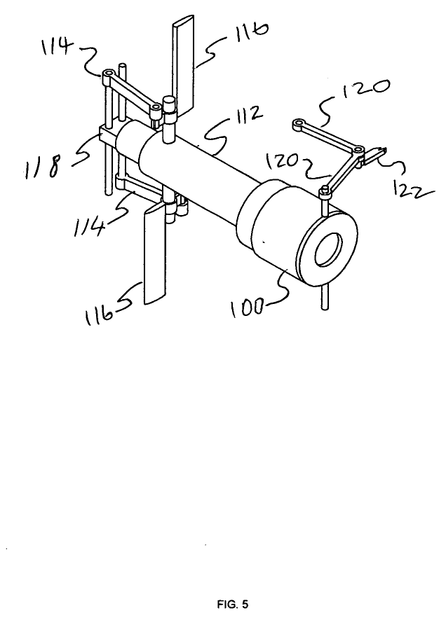

FIG. 3 illustrates exploded view and FIG. 5 illustrates assembly of present invention 10 for Yaw Control Command 18.

As main rotor blades 128 are rotating clockwise, body of helicopter becomes subject to a torque couple and will have a tendency to rotate in opposite direction of main rotor blades' rotation or counter clockwise.

In order to counter torque couple or add to torque couple, a helicopter's pilot 12 will use two rudder pedals to rotate helicopter's fuselage in clockwise direction 38 to counter torque created by main rotor or counter clockwise direction 36 to let the torque and less pitch and horsepower turn the fuselage left. This is in addition to the signal 66 going into Tail rotor Control Computer 124 from Gyroscope 126.

Gyroscope 126 is capable of measuring the amount of torque exerted on the fuselage and sends a signal 66 to Tail rotor Control Computer 124 and from there to servo (not shown) to move rudder control linkage 122 to change yaw so that it will remain steady in the same direction and prevent it from spinning out of control.

There are two rudder pedals: left rudder pedal and right rudder pedal. Helicopter's pilot 12 will push right rudder pedal down 38, to turn helicopter's fuselage to right, and will push left rudder pedal down 36, to turn helicopter's fuselage to left. Rudder pedals will be applied when helicopter is hovering and the pilot decides to turn right or left.

An example is provided: Assuming that helicopter pilot 12 has applied a positive pitch to main rotor 128 and helicopter is off the ground. Since main rotor is rotating clockwise, a signal 66 from the Gyroscope 126, measuring torque will be input to Tail rotor Control Computer 124 and from there output two signals one, 48 to servo (not shown) that will move Rudder Control Linkage 122 and change the pitch of the tail rotor Blades 116 and simultaneously another signal 46 to increase either torque or horsepower to Motor Shaft 112 in order to turn helicopter's fuselage to right. Helicopter pilot 12 will push down right rudder pedal 38, which will be in addition to input 66 from Gyroscope 126 to Tail rotor Control Computer 124 increasing pitch angles of Tail Rotor Bladel 16 and turning fuselage clockwise.

To turn left, pilotl2 will push left rudder pedal down 36. This will send a left turn signal 36 to Tail rotor Control Computer 124 which is also receiving a signal 66 from Gyroscope, and from there simultaneously two signals 56 to Motor Shaft 112 to decrease torque or horsepower and another signal, 58 to a servo (not shown) to move Rudder Control Linkage 122 and decrease tail rotor blades' pitch. Since there is less torque available to counter, fuselage will turn left.

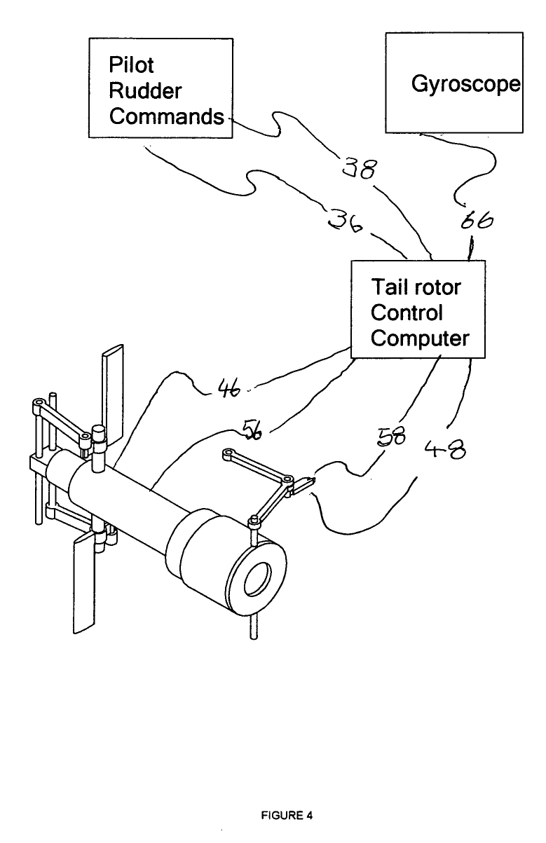

Both rudder pedals are connected to Tail rotor Control Computer 124, which also takes an input signal 66 from the Gyroscope 126. The Tail rotor Control Computer 124 is connected to rudder Control Linkage 122 by a mechanism such as servos (not shown) and also connected electronically to Motor Shaft 112 (FIG. 4).

Left rudder pedal will decrease pitch angle of blade 116 and decrease torque or horsepower using signals 56 and 46. When helicopter pilot 12 is pushing left pedal down, left pedal will cause Rudder control Linkage 122 to be pulled, thus moving Pitch Control Servo away from Motor Shaft 112 decreasing pitch angle of rotor blade 116, simultaneously decreasing torque or horsepower to 112. When helicopter pilot is pushing right pedal down, right pedal will cause Rudder Control Linkage 122 to be pushed, therefore, increasing pitch angle on Blade 116 desired angle and increasing torque or horsepower to 112.

Description of Part Numbers
100: Pitch Servo Control
112: Motor Shaft
114: Pitch Linkage
116: Rotor Blade
118: Pitch Control Servo Shaft
120: Pitch Slide Linkage
122: Rudder Control Linkage
124: Tail rotor Control Computer
126: Gyroscope
128: Main Rotor

What is claimed is:

1. A Computer Controlled Tail rotor anti-torque apparatus, compromising:
A Gyroscope measuring torque due to Main rotor's rotation.
A Computer, which can input signals from Gyroscope and Rudder pedals, and output two signals, one for pitch servo adjustment and the other for torque or horsepower change.
An Electric motor with variable speed control that responds to a computer signal.
A servomotor that responds to signal received from computer to move a mechanical arm.

2. An apparatus according to claim 1, where said yaw control comprising:
A Computer Controlled Rudder Control Linkage;
A Pitch Slide Linkage;
A Pitch Control Servo;
A Pitch Control Servo Shaft;
A Motor Shaft;
A Pitch Linkage
Two anti-torque tail rotor blades.
